(19) United States
(12) Patent Application Publication
(10) Pub. No.: US 2021/0406823 A1
(43) Pub. Date: Dec. 30, 2021

(54) SYSTEM AND METHOD FOR AUTOMATICALLY DETECTING AND RESOLVING ITEM DELIVERY ISSUES IN DISTRIBUTION NETWORK

(71) Applicant: United States Postal Service, Washington, DC (US)

(72) Inventors: David C. Lin, Falls Church, VA (US); Shahpour Ashaari, Bethesda, MD (US)

(21) Appl. No.: 17/359,119

(22) Filed: Jun. 25, 2021

Related U.S. Application Data
(60) Provisional application No. 63/044,580, filed on Jun. 26, 2020.

(51) Int. Cl. G06Q 10/08; G06Q 30/00

(52) U.S. Cl. CPC G06Q 10/0838; G06Q 10/0833; G06Q 30/016

(57) ABSTRACT

A system and method for automatically detecting and resolving item delivery issues in a distribution network is described. The system may include a memory configured to store electronic records of a plurality of items received by the distribution network. The system may further include a processor in data communication with the memory. The processor may process the electronic records of the plurality of items and determine whether there is a delivery issue on at least one of the plurality of items based on the electronic records. The processor may further automatically generate an internal case file in response to determining that there is a delivery issue on the at least one item and send notification to an intended recipient of the at least one item having the delivery issue.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims priority to and the benefit of Provisional Application No. 63/044,580 filed on Jun. 26, 2020 in the U.S. Patent and Trademark Office, the entire contents of which are incorporated herein by reference.

### BACKGROUND

The described technology generally relates to item processing, and in particular to a system and method for automatically detecting and resolving item delivery issues in a distribution network.

The distribution network may have many items in process or transit at any time. Gains in efficiency can be realized by automating identification and handling of items in the distribution network.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing systems, devices, and methods for processing items in a distribution network.

One aspect is a system for automatically detecting and resolving item delivery issues in a distribution network, comprising: a memory configured to store electronic records of a plurality of items received by the distribution network; and a processor in data communication with the memory and configured to: process the electronic records of the plurality of items; determine whether there is a delivery issue on at least one of the plurality of items based on the electronic records; automatically generate an internal case file in response to determining that there is a delivery issue on the at least one item; and send notification to an intended recipient of the at least one item having the delivery issue. In the above system, the notification comprises one or more of an updated delivery date, an upgraded service class or an explanation of the delivery issue for the at least one item.

In the above system, the processor is further configured to: communicate data with a carrier terminal and/or an operator terminal; and receive item processing information from the carrier terminal and/or the operator terminal, the item processing information comprising one or more of arrival scan data, out for delivery scan data, delivery scan data or acceptance scan data. In the above system, in determining whether there is a delivery issue on an item, the processor is further configured to: determine whether an arrival scan on the item is missing; determine whether an out for delivery scan on the item is missing; and determine that there is a delivery issue on the item in response to determining that the arrival scan is missing, or that the out for delivery scan is missing.

In the above system, the processor is configured to determine that there is no delivery issue on the item in response to determining that the arrival scan on the item is not missing, and that the out for delivery scan on the item is not missing. In the above system, in determining whether there is a delivery issue on an item, the processor is further configured to: determine a delivery scan location of the item in which a delivery scan on the item has been made; compare the delivery scan location with an actual destination coordinate of the item; and determine that there is a delivery issue on the item when the delivery scan location is over a predetermined distance away from the actual destination coordinate.

In the above system, the processor is configured to determine that there is no delivery issue on the item when the delivery scan location is within the predetermined distance from the actual destination coordinate. In the above system, in determining whether there is a delivery issue on an item, the processor is further configured to: retrieve an electronic record of the item from the memory; retrieve arrival scan data or acceptance scan data for the item; compare the electronic record of the item with item information contained in the arrival scan data or the acceptance scan data; and determine that there is a delivery issue on the item when there is a discrepancy between the electronic record of the item and the item information contained in the arrival scan data or the acceptance scan data.

In the above system, the processor is configured to determine that there is no delivery issue on the item when the electronic record of the item matches the item information contained in the arrival scan data or the acceptance scan data.

In the above system, in determining whether there is a delivery issue on an item, the processor is further configured to: receive pre-shipment information of the item; determine whether an item acceptance scan has been made on the item; determine whether the item acceptance scan has been made within a predetermined time from a time when the pre-shipment information of the item was received; and determine that there is a delivery issue on the item in response to determining that the item acceptance scan has not been made or that the item acceptance scan has not been made within the predetermined time.

In the above system, the processor is configured to determine that there is no delivery issue on the item in response to determining that the item acceptance scan has been made within the predetermined time. In the above system, in determining whether there is a delivery issue on an item, the processor is further configured to: retrieve an electronic record of the item; determine that an out for delivery scan has been made on the item; determine whether an item delivery scan has been made on the item; determine whether the item delivery scan has been made by a predetermined local time in an area where an intended recipient resides; and determine that there is a delivery issue on the item in response to determining that the item delivery scan has not been made or that the item delivery scan has not been made by the predetermined local time.

In the above system, the processor is configured to determine that there is no delivery issue on the item in response to determining that the item delivery scan has been made by the predetermined local time. In the above system, the at least one item having the delivery issue comprises a tracking device disposed on, embedded into or attached thereto, and wherein the processor is configured to track a location of the at least one item based on the tracking device in response to determining that there is a delivery issue on the at least one item.

Another aspect is a method of automatically detecting and resolving item delivery issues in a distribution network, comprising: storing, at a memory, electronic records of a plurality of items received by the distribution network; and processing, at a processor, the electronic records of the plurality of items; determining, at the processor, whether there is a delivery issue on at least one of the plurality of items based on the electronic records; automatically generating, at the processor, an internal case file in response to determining that there is a delivery issue on the at least one item; and sending, at the processor, notification to an intended recipient of the at least one item having the delivery issue.

In the above method, the notification comprises one or more of an updated delivery date, an upgraded service class or an explanation of the delivery issue for the at least one item. In the above method, the storing comprises storing, at the memory, item processing information comprising one or more of item arrival scan data, out for delivery scan data, item delivery scan data or item acceptance scan data. In the above method, the determining comprises: determining, at the processor, whether an arrival scan on an item is missing; determining, at the processor, whether an out for delivery scan on the item is missing on the item; and determining, at the processor, that there is a delivery issue on the item in response to determining that the arrival scan is missing, or that the out for delivery scan is missing.

In the above method, the determining comprises determining, at the processor, that there is no delivery issue on the item in response to determining that the arrival scan is not missing, and that the out for delivery scan is not missing. In the above method, the determining comprises: determining, at the processor, a delivery scan location of an item where a delivery scan on the item has been made; comparing, at the processor, the delivery scan location with an actual destination coordinate of the item; and determining, at the processor, that there is a delivery issue on the item when the delivery scan location is over a predetermined distance away from the actual destination coordinate.

In the above method, the determining comprises determining, at the processor, that there is no delivery issue on the item when the delivery scan location is within the predetermined distance from the actual destination coordinate. In the above method, the determining comprises: retrieving, at the processor, an electronic record of an item from the memory; retrieving, at the processor, arrival scan data or acceptance scan data on the item; comparing, at the processor, the electronic record of the item with item information contained in the arrival scan data or the acceptance scan data; and determining, at the processor, that there is a delivery issue on the item when there is a discrepancy between the electronic record of the item and the item information contained in the arrival scan data or the acceptance scan data.

In the above method, the determining comprises determining, at the processor, that there is no delivery issue on the item when the electronic record of the item matches the item information contained in the arrival scan data or the acceptance scan data. In the above method, the determining comprises: retrieving, at the processor, pre-shipment information of an item; determining, at the processor, whether an item acceptance scan on the item has been made; determining, at the processor, whether the item acceptance scan on the item has been made within a predetermined time from a time when the pre-shipment information of the item was received; and determining, at the processor, that there is a delivery issue on the item in response to determining that the item acceptance scan has not been made or that the item acceptance scan has not been made within the predetermined time.

In the above method, the determining comprises determining, at the processor, that there is no delivery issue on the item in response to determining that the item acceptance scan has been made within the predetermined time. In the above method, the determining comprises: retrieving, at the processor, an electronic record of an item from the memory; determining, at the processor, that an out for delivery scan on the item has been made; determining, at the processor, whether an item delivery scan on the item has been made on the item; determine whether the item delivery scan has been made by a predetermined local time in an area where an intended recipient resides; and determining, at the processor, that there is a delivery issue on the item in response to determining that the item delivery scan has not been made or that the item delivery scan has not been made by the predetermined local time. In the above method, the determining comprises determining, at the processor, that there is no delivery issue on the item in response to determining that the item delivery scan has been made by the predetermined local time.

Another aspect is a system for automatically detecting and resolving item delivery issues in a distribution network, comprising: means for storing electronic records of a plurality of items received by the distribution network, the storing means comprising a memory; and means for processing the electronic records of the plurality of items; means for determining whether there is a delivery issue on at least one of the plurality of items based on the electronic records; means for automatically generating an internal case file in response to determining that there is a delivery issue on the at least one item; and means for sending notification to an intended recipient of the at least one item having the delivery issue, at least one of the processing means, the determining means, the automatically generating means or the sending means comprising a processor.

Another aspect is a system for automatically detecting and resolving item delivery issues in a distribution network, comprising: a memory configured to store electronic records of a plurality of items received by the distribution network; and a processor in data communication with the memory and configured to: process the electronic records of the plurality of items; determine whether there is a delivery issue on at least one of the plurality of items based on the electronic records; automatically initiate a corrective action in response to determining that there is a delivery issue on the at least one item; and send notification to a computing device of an intended recipient of the at least one item having the delivery issue.

In the above system, the notification comprises one or more of an updated delivery date, an upgraded service class or an explanation of the delivery issue for the at least one item having the delivery issue. In the above system, the processor is further configured to: receive item processing information from at least one of a carrier terminal or an operator terminal in data communication with the distribution network, the item processing information comprising one or more of arrival scan data, out for delivery scan data, delivery scan data or acceptance scan data associated with the plurality of items.

In the above system, the processor is further configured to: determine whether an arrival scan for the at least one item is missing; determine whether an out for delivery scan for the at least one item is missing; determine that there is a delivery issue on the at least one item in response to determining that at least one of the arrival scan or the out for delivery scan is missing. In the above system, the processor is further configured to: determine a delivery scan location of the at least one item in which a delivery scan on the at least one item occurred; compare the delivery scan location with an actual destination coordinate of the at least one item; and determine that there is a delivery issue on the at least one item when the delivery scan location is over a predetermined distance away from the actual destination coordinate.

In the above system, the processor is further configured to: retrieve an electronic record of the at least one item from the memory; retrieve arrival scan data or acceptance scan data for the at least one item; compare the electronic record of the at least one item with item information contained in the arrival scan data or the acceptance scan data; and determine that there is a delivery issue for the at least one item when there is a discrepancy between the electronic record of the at least one item and the item information contained in the arrival scan data or the acceptance scan data.

In the above system, the processor is further configured to: receive pre-shipment information of the at least one item; determine whether an item acceptance scan for the at least one item has occurred; determine whether the item acceptance scan for the at least one item occurred within a predetermined time from a time when the pre-shipment information of the at least one item was received; and determine that there is a delivery issue for the at least one item in response to determining that the item acceptance scan has not occurred or that the item acceptance scan has not occurred within the predetermined time.

In the above system, the processor is further configured to: retrieve an electronic record of the at least one item; determine that an out for delivery scan for the at least one item has occurred; determine whether an item delivery scan for the at least one item has occurred; determine whether the item delivery scan has occurred by a predetermined local time in an area where an intended recipient resides; and determine that there is a delivery issue on the at least one item in response to determining that the item delivery scan has not been made or that the item delivery scan has not been made by the predetermined local time. In the above system, the at least one item having the delivery issue comprises a tracking device disposed on, embedded into or attached thereto, and wherein the processor is configured to track a location of the at least one item based on the tracking device in response to determining that there is a delivery issue on the at least one item.

Another aspect is a method of automatically detecting and resolving item delivery issues in a distribution network, comprising: storing, at a memory, electronic records of a plurality of items received by the distribution network; and processing, at a processor, the electronic records of the plurality of items; determining, at the processor, whether there is a delivery issue on at least one of the plurality of items based on the electronic records; automatically generating, at the processor, an internal case file in response to determining that there is a delivery issue on the at least one item; and sending, at the processor, notification to a computing device of an intended recipient of the at least one item having the delivery issue.

In the above method, the notification comprises one or more of an updated delivery date, an upgraded service class or an explanation of the delivery issue for the at least one item. In the above method, the storing comprises storing, at the memory, item processing information comprising one or more of item arrival scan data, out for delivery scan data, item delivery scan data or item acceptance scan data associated with the plurality of items. In the above method, the determining comprises: determining, at the processor, whether an arrival scan on an item is missing; determining, at the processor, whether an out for delivery scan for the at least one item is missing on the at least one item; determining, at the processor, that there is a delivery issue on the at least one item in response to determining that at least one of the arrival scan or the out for delivery scan is missing; and determining, at the processor, that there is no delivery issue on the at least one item in response to determining that neither of the arrival scan and the out for delivery scan is missing.

In the above method, the determining comprises: determining, at the processor, a delivery scan location of an item where a delivery scan for the at least one item has occurred; comparing, at the processor, the delivery scan location with an actual destination coordinate of the at least one item; and determining, at the processor, that there is a delivery issue on the at least one item when the delivery scan location is over a predetermined distance away from the actual destination coordinate. In the above method, the determining comprises: retrieving, at the processor, an electronic record of an item from the memory; retrieving, at the processor, arrival scan data or acceptance scan data on the at least one item; comparing, at the processor, the electronic record of the at least one item with item information contained in the arrival scan data or the acceptance scan data; and determining, at the processor, that there is a delivery issue on the at least one item when there is a discrepancy between the electronic record of the at least one item and the item information contained in the arrival scan data or the acceptance scan data.

In the above method, the determining comprises: retrieving, at the processor, pre-shipment information of an item; determining, at the processor, whether an item acceptance scan for the at least one item has occurred; determining, at the processor, whether the item acceptance scan for the at least one item has occurred within a predetermined time from a time when the pre-shipment information of the item was received; and determining, at the processor, that there is a delivery issue on the at least one item in response to determining that the item acceptance scan has not been made or that the item acceptance scan has not been made within the predetermined time.

In the above method, the determining comprises: retrieving, at the processor, an electronic record of an item from the memory; determining, at the processor, that an out for delivery scan for the at least one item has occurred; determining, at the processor, whether an item delivery scan for the at least one item has occurred; determining whether the item delivery scan has occurred by a predetermined time; and determining, at the processor, that there is a delivery issue for the at least one item in response to determining that the item delivery scan has not been made or that the item delivery scan has not been made by the predetermined local time.

Another aspect is a system for automatically detecting and resolving item delivery issues in a distribution network, comprising: means for storing electronic records of a plurality of items received by the distribution network, the storing means comprising a memory; and means for processing the electronic records of the plurality of items; means for determining whether there is a delivery issue on at least one of the plurality of items based on the electronic records; means for automatically generating an internal case file in response to determining that there is a delivery issue on the at least one item; and means for sending notification to a computing device of an intended recipient of the at least one item having the delivery issue, at least one of the processing means, the determining means, the automatically generating means or the sending means comprising a processor.

In the above system, the notification comprises one or more of an updated delivery date, an upgraded service class or an explanation of the delivery issue for the at least one item. The above system further comprises: means for receive item processing information from at least one of a carrier terminal or an operator terminal in data communication with the distribution network, the item processing information comprising one or more of arrival scan data, out for delivery scan data, delivery scan data or acceptance scan data associated with the plurality of items.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates a diagram of a distribution system or network used to distribute items between shippers and recipients.

FIG. 2 is a block diagram of a system for automatically detecting and resolving item delivery issues in a distribution network according to some embodiments.

FIG. 3 is an exemplary process flow diagram of a method for automatically detecting and resolving item delivery issues in a distribution network according to some embodiments.

FIG. 4 is an exemplary process flow diagram of a method for automatically detecting item delivery issues in the distribution network according to some embodiments.

FIG. 5 is an exemplary process flow diagram of a method for automatically detecting item delivery issues in the distribution network according to some embodiments.

FIG. 6 is an exemplary process flow diagram of a method for automatically detecting item delivery issues in the distribution network according to some embodiments.

FIG. 7 is an exemplary process flow diagram of a method for automatically detecting item delivery issues in the distribution network according to some embodiments.

FIG. 8 is an exemplary process flow diagram of a method for automatically detecting item delivery issues in the distribution network according to some embodiments.

### DETAILED DESCRIPTION

Provided herein are various embodiments of systems and methods for automatically detecting and resolving item delivery issues in a distribution network. Embodiments described herein can significantly reduce customer call volumes and times, and time spent searching for delayed/missing packages so that the functionality of computing devices such as an item processing system is significantly improved. Embodiments described herein can also improve responsiveness and quality of service and thus can better manage customer expectations.

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary from figure to figure. The illustrative embodiments described in the detailed description, drawings, and claims are not meant to be limiting. Some embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification do not necessarily all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

As used here, the term “item” or “items” may refer to flats, letters, parcels, residual mail, and the like. Although the present disclosure describes systems and devices for image processing related to articles of mail, such as letters and flats, it will be apparent to one of skill in the art that the disclosure presented herein is not limited thereto. For example, the described technology may have application in a variety of manufacturing, assembly, distribution, or sorting applications which include processing images including personal or sensitive information at high rates of speed and volume.

Where a plurality of images are captured, large volumes of data are created. This can be the case in various applications, such as recording video, photographing items, such as archives, and other applications where multiple images are being captured. A large amount of data is generated when handling items through processing systems. Handling items can include capturing one or more images of the item as it is being processed. For example, items, such as articles of mail (e.g., letters, flats, parcels, and the like), warehouse inventories, or packages are frequently received into a processing facility in bulk, and must be sorted into particular groups to facilitate further processes such as, for example, delivery of the item to a specified destination. Sorting items or articles can be done using imaging technologies. The ability to accurately process a given item may be limited by the effectiveness of the imaging technology to extract accurate information about each item. The information may include personal information about the sender or receiver of the item such as name, address, account information, or other information that is provided in trust that public disclosure will be limited if not avoided altogether. Careful handling of the personal information includes careful handling of images taken of the item during processing. Mail delivery is one example of an industrial application that relies on sorting and processing large quantities of items. Others may include, but are not limited to, retail operations with large inventories and high daily sales, high volume component manufacturers, such as consumer goods, baggage sorting, and importing operations with high volumes of imports needing sorting and receiving daily.

Distribution items such as mailpieces or parcels are processed on item processing equipment which can scan the items to obtain the information, e.g., addresses, types of items, barcode, etc. An item processing facility can use automated processing equipment to sort items. The item processing facility may receive a very high volume of items, such as mailpieces, letters, flats, parcels, or other objects which must be sorted and/or sequenced for delivery. Sorting and/or sequencing may be accomplished using item processing equipment which can scan, read, or otherwise interpret a destination end point from each item processed. The destination end point may be encoded in a computer readable code, such as a barcode printed on or affixed to the item. In some embodiments, the destination end point may be read by taking an image of the item and performing an optical character recognition (OCR) process on the image, and determining the delivery end point from the OCR'd address. In some embodiments, the item processing equipment can apply a computer readable code that encodes the delivery end point and may print or spray the computer readable code onto the item.

An item distribution system or distribution network, such as the United States Postal Service (USPS) or other shipping or item delivery service, logistics service, or other entity may process and/or deliver items, such as letters, flats, parcels, packages, and bulky items to a plurality of delivery points or destinations. The USPS will be used in the described technology to describe some exemplary embodiments, but the described technology is not limited thereto. When referencing generically to any of the services listed above or any item distribution service in addition to those listed above, the phrase “item distribution service,” “delivery service,” or “distribution system” will be used to indicate such generalities. The terms mail or mailpiece may be used to illustrate exemplary embodiments, but these terms are not intended to be limiting.

The distribution network may comprise multiple levels. For example, the distribution network may comprise regional distribution facilities, hubs, and unit delivery facilities, or any other desired level. A nationwide distribution network, for example, may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the USPS, the unit delivery facility may be associated with a ZIP Code. The unit delivery facility receives items from local senders, and from hub level facilities or regional distribution facilities. The unit delivery facility also sorts and stages the items intended for delivery to destinations within the unit delivery facility's coverage area.

Generally, when a sender desires to ship an item, the item is provided to the distribution network. When the item is onboarded or taken into the distribution network, the network needs to identify the item or needs to generate and/or assign a unique identifier to the item so the item can be tracked through the distribution network and unique identified on item processing equipment, such as item sorters, mail processing equipment, etc. Identifying the item, a label on the item, writing on the item, such as an address, etc., can be done manually or using optical character recognition (OCR), or other resource intensive identification techniques. After identifying the item, the distribution network can then produce a unique, computer readable identifier for the item, which is used for handling events and tracking of the item throughout the distribution network.

When processing a high volume of items, errors may occur, items may be misdirected, misdelivered, may be stuck to other items such that an item may not be scanned, a delivery resource may fail to scan an item, and for other reasons. When an error occurs, the error may place the service standard in jeopardy. For example, when an error occurs on an item that has a delivery guarantee time or date, the error, without any intervening action, may cause late delivery of the item. In some cases, an error may result in an item not being delivered at all, or being delivered to an incorrect location, or may result in an abnormally long transit time from origin to intended destination. It can be advantageous to identify such errors when they occur or soon after they occur in order to implement corrective or intervening action for the item.

In an exemplary aspect described herein, the systems and methods described herein can identify errors and take corrective action without operator input, or by triggering or initiating operator intervention. The systems and methods can identify, based on scan information, location information, expected information, and the other item information, when an item is, for example, mis-routed, in an incorrect location according to a delivery plan, a scan is missed, and the like. The systems and methods can cause automatic investigation and corrective action, and can provide alerts to delivery resources. The systems and methods can also include notifications to intended recipients that an item may be delayed, and can provide information about the item and the delay to the intended recipient.

Additionally, a customer who experiences a delivery delay may request information from the distribution network as to why item is delayed. When a customer requests information, the systems and methods can provide tracking information, scan history, item location, and the like in an automated system for the customer.

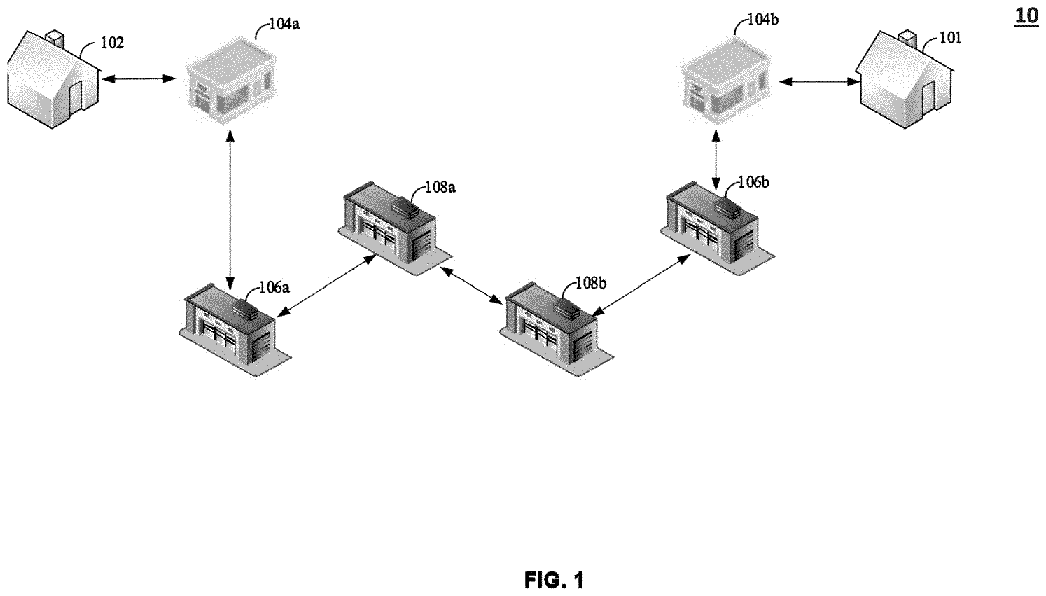

FIG. 1 illustrates a diagram of a distribution network 10 (to be interchangeably used with a distribution system) that can be used to distribute items between shippers 102 and recipients 101. The distribution network 10 may be employed by an item delivery service to distribute items received and to be delivered across a geographic area. The distribution network 10 includes various distribution points or facilities. In some embodiments, the distribution network 10 may include more or fewer distribution points or facilities than shown in the distribution network 10. For example, the distribution network 10 includes unit delivery facilities 104a and 104b (e.g., post offices or drop-off locations). The distribution network 10 may also include semi-regional facilities 106a and 106b (e.g., sectional center facilities) and regional facilities 108a and 108b (e.g., network distribution centers or distribution hubs).

The unit delivery facilities 104a and 104b may correspond to a facility that receives and delivers items destined to recipients 101 within a given geographic area. Customer service supervisors, carriers and clerks may work in the unit delivery facilities 104a and 104b. In some embodiments, the unit delivery facilities 104a and 104b may also sort items before delivery. While customer service supervisors generally work in the unit delivery facilities 104a and 104b, mail processing supervisors and operators may also work in the unit delivery facilities 104a and 104b, for example, when the unit delivery facilities 104a and 104b have the capability to sort items before delivery. Carriers may pick up items from the unit delivery facility 104b and deliver the items to the recipients 101. In some embodiments, carriers may also pick up items from the shippers 102 and drop them off at the unit delivery facility 104a. Truck drivers may move items between the unit delivery facilities 104a and 104b, and the semi-regional facilities 106a and 106b. Truck drivers may also move items between the semi-regional facilities 106a and 106b, and the regional facilities 108a and 108b.

In the case of the USPS, the unit delivery facilities 104a and 104b may be associated with a region covered by a ZIP Code™ (a trademark of the USPS). In these embodiments, the unit delivery facilities 104a and 104b may receive items from the semi-regional facility 106a that serves it. These items received from the semi-regional facilities 106a and 106b may be delivered by the unit delivery facilities 104a and 104b (e.g., via a mail carrier route, etc.) to the appropriate destination within its covered geographic area. Accordingly, as discussed above, the unit delivery facilities 104a and 104b may also sort and stage the items intended for delivery to destinations/recipients within the delivery unit's coverage area.

The unit delivery facilities 104a and 104b may also serve to induct items into the distribution network 10. When serving as an intake facility, items that are inducted at the unit delivery facilities 104a, 104b into the distribution network 10 may be sent to the semi-regional facilities 106a and 106b. In some embodiments, the unit delivery facilities 104a and 104b may receive items from local shippers, from semi-regional facilities 106a and 106b, or regional facilities 108a and 108b. While the delivery unit 104a is shown as the intake facility, any of the semi-regional and regional facilities 106a and 106b, and 108a and 108b, respectively, or other facilities not shown, may serve as the intake facility.

The semi-regional facilities 106a and 106b may receive and distribute items between multiple unit delivery facilities 104a and 104b and the associated regional facilities 108a and 108b. In the case of the USPS, the semi-regional facilities 106a and 106b may each be associated with a geographic region covered by the first three numbers of a ZIP code. The semi-regional facility 106a may serve as a processing and distribution center for the respective multiple unit delivery facilities 104a and 104b within its respective geographic areas. In some embodiments, the semi-regional facility 106a may receive items from the regional facility 108a for distribution to its respective delivery unit 104a. In some embodiments, the semi-regional facility 106a may receive items from its delivery unit 104a, for distribution to other delivery units 104b or the regional facility 108a. Mail processing supervisors may work with operators in the semi-regional facilities 106a and 106b.

The regional facilities 108a and 108b may receive and distribute items between multiple semi-regional facilities 106a and 106b and other regional facilities. In the case of the USPS, the regional facility 108a or 108b may be associated with a region covered by a state or a group of states, etc. The regional facilities 108a and 108b may serve as processing and distribution centers for the respective multiple semi-regional facilities 106a and 106b within their respective geographic areas. In some embodiments, the regional facility 108a may receive items from the semi-regional facility 106a for distribution to another semi-regional facility 106b that the regional facility 108a serves. In some embodiments, the regional facility 108a may receive items from its semi-regional facilities 106a and 106b for distribution to other regional facilities, e.g., the regional facility 108b. Mail processing supervisors may also work with operators in the regional facilities 108a and 108b.

When the item enters the distribution network 10 at the intake facility (e.g., regardless of delivery unit 104a, semi-regional facility 106a, and regional facility 108a), the item may be scanned, routed according to intended destination, and tracked through all sortation and distribution steps through which the item may pass. In some embodiments, such tracking may be individual to the item or be aggregate for volumes of items. The tracking may occur until the item is delivered to its destined recipient or until the item leaves a delivery unit 104b for delivery to its destined recipient.

In some embodiments, the distribution network 10, as shown, may be a national distribution network 10 that includes multiple regional facilities 108a and 108b, multiple semi-regional facilities 106a and 106b, and multiple unit delivery facilities 104a and 104b, each having a defined coverage area, such as a geographic area and designated to receive and/or delivery items to/from recipients and senders in the geographic area.

As described herein, the distribution network 10 employed may comprise numerous pieces of mail processing equipment located in various facilities and at each level within the distribution network 10 (described and undescribed) that may scan identifiers on the items, take images of the items, interpret delivery point information from the scans or images of the items, automatically sort and route items according to the delivery point information indicated on the items, physical characteristics of the items, and/or postage characteristics. For example, these pieces of equipment identify delivery point information that is located on the items being processed and reference stored information associated with the identified delivery point information to assist in the sorting and routing of the item.

A processing facility can use automated processing equipment to sort items. Where the distribution network 10 is the USPS, every day a processing facility receives a very high volume of items, such as letters and flats, which must be sorted and sequenced for delivery on mail processing equipment. Sorting and sequencing may be accomplished using automated sorting equipment which can scan, read, or otherwise interpret a destination end point from each item processed. The destination end point may be encoded in a computer readable code, such as a bar code printed on or affixed to the item. In some embodiments, the destination end point may be read by taking an image of the item and performing an optical character recognition (OCR) process on the image, and determining the delivery end point from the OCR'd address. In some embodiments, the automated sorting equipment can apply a computer readable code that encodes the delivery end point and may print or spray the computer readable code onto the item. In some embodiments, the processing facility uses sorting/sequencing apparatuses which can process about 30,000 items per hour. A typical USPS processing facility may also serve about 200 or more delivery routes, each with multiple delivery end points. The item processing equipment can then move the item to a plurality of destination locations within the equipment using belts, conveyors, pneumatics, and other features, to move the item. The plurality of destinations can be bins, stackers, shelves, etc., which are each associated with one or more delivery points.

When an item is inducted, a delivery plan is generated, which includes a path the item should take through the distribution network 10 to deliver the item to the intended destination.

The delivery plan may provide the most efficient path through the distribution network 10. The delivery plan may also take into account a service class, or a delivery guarantee. Systems can store the proposed delivery plan for each item in the distribution network. The sorting equipment receives the delivery plan and processes items according to the delivery plan. Items in the distribution network 10 are processed at each phase of the distribution network 10. The scans of the items at each phase of the distribution system are stored and can be compared to the delivery plan.

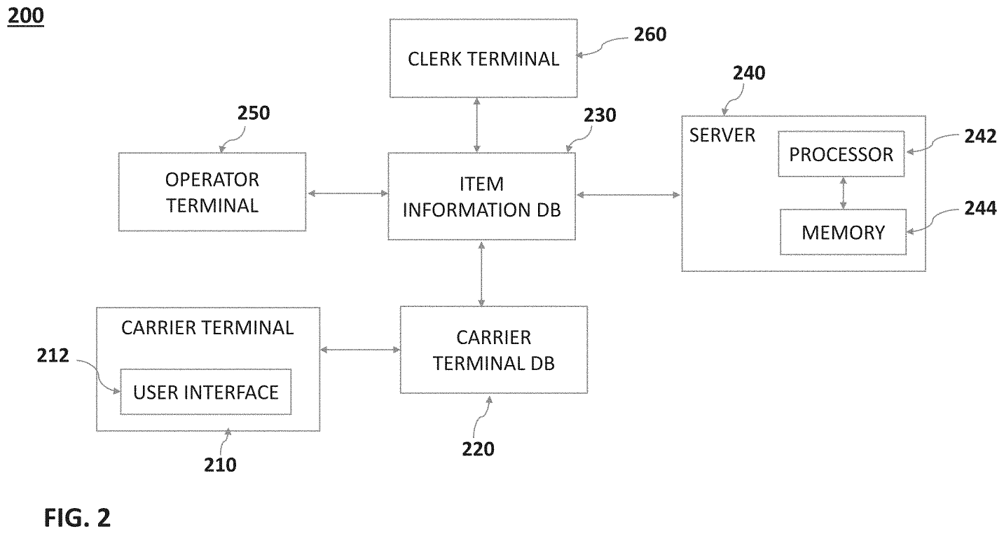

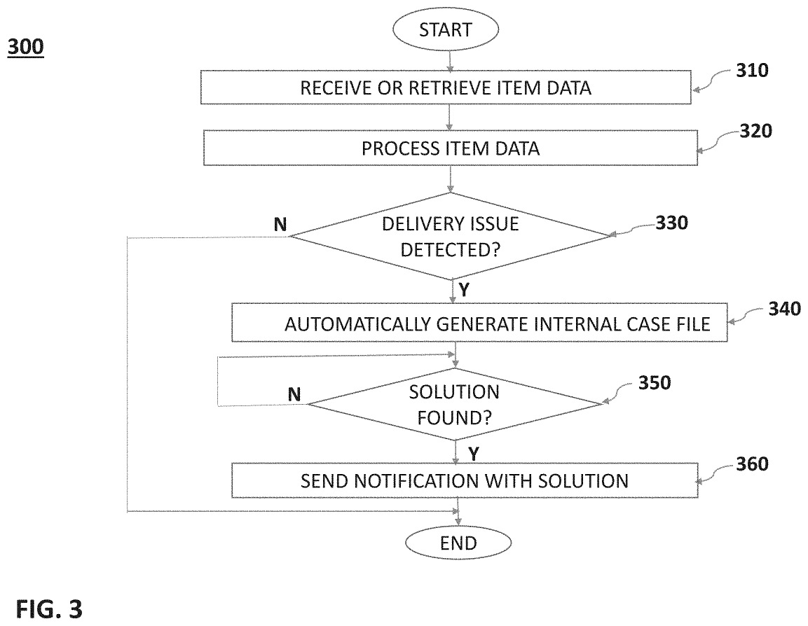

FIG. 2 is a block diagram of a system 200 for automatically detecting and resolving item delivery issues in the distribution network 10 according to some embodiments. The system 200 may include a carrier terminal 210, a carrier terminal database (DB) 220, an item information DB 230, a server 240, an operator terminal 250 and a clerk terminal 260. The elements 210-260 may be connected with each other either wirelessly or by wire. The elements 210-260 may directly or indirectly communicate data with each other. The system 200 shown in FIG. 3 is merely an example processing system, and certain elements may be modified or removed, two or more elements combined into a single element, and/or other elements or equipment may be added. The operator terminal 250 can be a mobile or stationary computing device used by distribution network personnel, for example, in a warehouse or other distribution network facility where items are received and/or inducted to the facility and/or the distribution network. The operator terminal 250 may have a scanning device, such as a barcode scanner, an optical reader, etc. Items may be scanned by an operator using the operator terminal 250, or the operator terminal 250 can be a part of item processing equipment which automatically moves the items past the operator terminal 250 to be imaged, scanned, read, etc.

The clerk terminal 260 can be a device in a retail location, such as a post office or retail store. A clerk or employee can scan an item using the clerk terminal 260 when an item is sold, received, transferred from store inventory to a carrier, inducted, postage paid, etc.

The server 240 may include a processor 242 and a memory 244. The processor 242 may be implemented as software or hardware as part of a dedicated server or computer. The processor 242 may direct the operation of the server 240, including the interface and communication with the various other components of the system 200. The memory 244 can store instructions for directing the processor 242 and various other components of the system 200. The memory 244 may also store information or data used for the processor 242 to automatically detect and resolve item delivery issues in the distribution network 10. The information or data may include, but is not limited to, one or more of electronic records of items, various scan data such as item arrival scan data, out for delivery scan data, item acceptance scan data, and item delivery scan data, etc. The server 240 may communicate data with one or more of the elements 210-230, 250 or 260 in order to automatically detect and resolve delivery issues in the distribution network 10. For example, the server 240 or the processor 242 may perform one or more of the procedures shown in FIGS. 3-8 (to be described in greater detail).

The item information DB 230 may store data received by the distribution network 10. The item information DB 230 may communicate data with one or more of the carrier terminal 210, the carrier terminal DB 220, the server 240, the operator terminal 250 or the clerk terminal 260 either wirelessly or by wire. The item information DB 230 may store information or data including, but not limited to, one or more of electronic records of items, unique identifiers for the plurality of items and an association with the electronic record and item information, e.g., size, weight, destination, sender, service class, estimated or guaranteed delivery date, etc., and various item scan data such as arrival scan data, out for delivery scan data, acceptance scan data, delivery scan data, etc. The item information DB 230 may be located at or near one or more of the regional facilities 108a and 108b, or the semi-regional facilities 106a and 106b shown in FIG. 1. However, the present disclosure is not limited thereto, and the item information DB 230 may be located anywhere in the distribution network 10. In some embodiments, the item information DB 230 may be implemented with a network memory such as a cloud, or other device separately located from the elements 210-260.

The carrier terminal 210 may be operated by a distribution network resource, such as a carrier, a vehicle, or personnel. In some embodiments, a carrier can input data relating to item delivery or processing via the carrier terminal 210. For example, the carrier terminal 210 may perform scan operation, including but not limited to, an “out for delivery” scan and/or a delivery scan. The “out for delivery” scan may also be made by the operator terminal 250. The carrier may manually input data to the carrier terminal 210 which can be transmitted to the carrier terminal DB 220. In some embodiments, the carrier terminal 210 may include a barcode reader or scanner that can sense barcodes or read labels attached to items, and automatically send sensed data to the server 240. The carrier terminal 210 can include a mobile delivery device (MDD), that includes a location circuit, such as GPS, and which can provide real-time location data of the MDD, the associated carrier, and distribution items. The carrier terminal 210 may be one or more mobile devices such as a smartphone, a tablet or a laptop that can scan items and wirelessly communicate data with the server 240.

The carrier terminal 210 may include a user interface 212. The user interface 212 may provide the carrier with the ability to interact with one or more of the carrier terminal DB 220, the item information DB 230, the server 240, the operator terminal 250 or the clerk terminal 260. For example, the carrier terminal 210 may access the server 240 via the user interface 212 thereof and enter data in the server 240 using the user interface 212. The user interface 212 may include an electronic interface. The user interface 212 may be an Internet browser which a user points to a particular website. In some embodiments, the user interface 212 may be a mobile application. The mobile application may be stored and/or accessed from a smart phone, personal digital assistant, tablet computer, laptop computer, or other mobile communication device. The user interface 212 may interface or communicate data with the server 240 via a wired or wireless communication method. Where the user interface 212 is available on a smart phone or other mobile communication device, the interface between the user interface 212 and the elements 220-260 may be via a cellular network, a wireless fidelity network using an IEEE 802.11x protocol, a Bluetooth connection, or any other desired wireless communication method. In some embodiments, the user interface 212 may be useable by an individual through selecting options, features, and/or functions, inputting data, and requesting information. In some embodiments, the user interface 212 may be an automated program or routine which automatically inputs information regarding an item from a retailer's computer network, online sales website, or other similar functionality into the system 200.

The carrier terminal DB 220 may store data entered by the carrier terminal 210. The carrier terminal DB 220 may communicate data with the carrier terminal 210 and the item information DB 230 either wirelessly or by wire. The carrier terminal DB 220 may be located at or near a local item processing facility where the carrier works, for example, unit delivery facilities 104a and 104b shown in FIG. 1. However, the present disclosure is not limited thereto, and the carrier terminal DB 220 may be located at one or more of other facilities 106a-108b shown in FIG. 1. Furthermore, the carrier terminal DB 220 may be implemented with a network memory such as a cloud, or other device separately located from the elements 210 and 230-260. In these embodiments, the network memory can communicate data with the carrier terminal 210 wirelessly or by wire. In some embodiments, the carrier terminal DB 220 may be omitted. In these embodiments, the carrier terminal 210 may directly communicate data with the item information DB 230.

At least one of the operator terminal 250, carrier terminal 210, or the clerk terminal 260 may perform one or more of an item arrival at unit scan, an “out for delivery” scan, or an item acceptance or induction scan. The operator terminal 250 may communicate data with the item information DB 230 or the server 240 wirelessly or by wire. The scanned data may be stored in the item information DB 230 or the memory 244. Although not shown, at least one of the operator terminal 250 or the clerk terminal 260 may include a user interface that can receive input from the operator and communicate data with one or more of the remaining components of the system 200. In some embodiments, the clerk terminal 260 may be omitted.

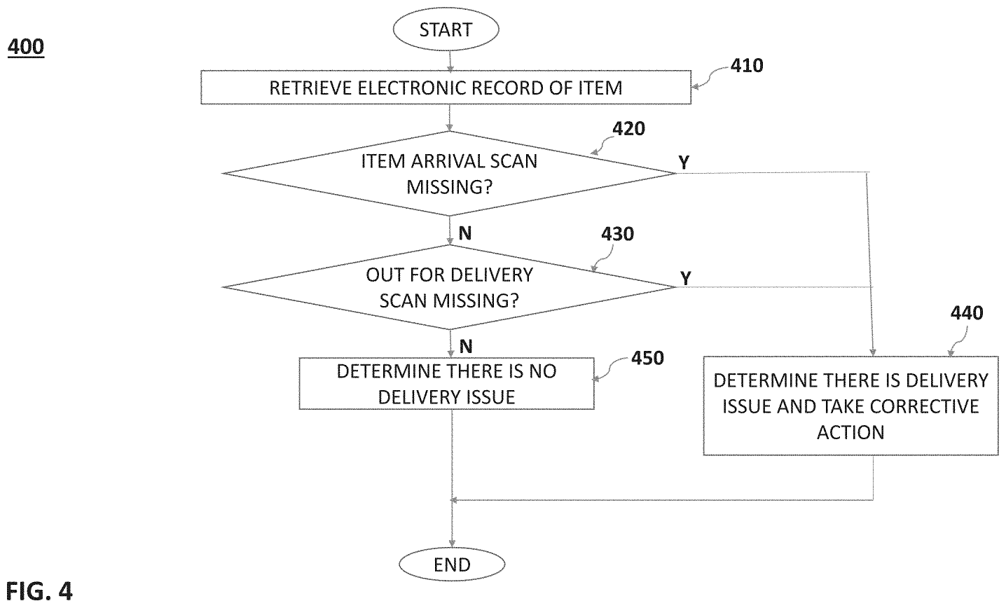

FIG. 3 is an exemplary process flow diagram 300 of a method for automatically detecting and resolving item delivery issues in the distribution network 10 according to some embodiments. In some embodiments, the process flow diagram 300 may be performed by the server 240. For example, the process flow diagram 300 may be performed by the processor 242. In other embodiments, the process flow diagram 300 may be performed by a computing device separate from and/or in data communication with the server 240. Computer readable instructions configured to execute the process flow diagram 300 may be stored in the memory 244. Although the process flow diagram 300 is described herein with reference to a particular order, in various embodiments, states herein may be performed in a different order, or omitted, and additional states may be added. The description of this paragraph may also apply to the process flow diagrams 400-800 shown in FIGS. 4-8.

For the purpose of convenience, the description will be provided based on the processor 242 performing the flow diagram 300. In state 310, the processor 242 may receive or retrieve item data. The processor 242 may receive the item data in various ways. For example, when at least one of a carrier, an operator or a clerk scans barcode information on an item via their respective terminals 210, 250 or 260, the processor 242 may receive the scanned data from one or more of the terminals and store the scanned data in the memory 244. The item data may also be stored in the processor 242. As another example, when a shipper drops an item at a unit facility such as 104a or 104b, an operator or clerk may input the relevant item information into the distribution network 10 so that the processor 242 may receive the item data. As another example, a shipper may be registered with the distribution network 10 and may directly enter the relevant item data into the distribution network 10. In some embodiments, the distribution network 10 may include an electronic manifest system. In these embodiments, the electronic manifest system may include manifest information of all items that entered the distribution network 10. In some embodiments, the processor 242 may store the received item data in the item information DB 230 or the carrier terminal DB 220. In other embodiments, the item information DB 230 may directly receive and store thereon the item data described above (i.e., without going through the server 240). In these embodiments, the processor 242 may retrieve the item data from the item information DB 230 or the carrier terminal DB 220.

In state 320, the processor 242 may process the received or retrieved item data. In some embodiments, where the processor 242 directly receives or stores the item data therein, the processor 242 may process the item data. In other embodiments, where the item information DB 230 directly receives and stores the item data thereon, the processor 242 may retrieve the item data from the item information DB 230 and process the retrieved item data. In some embodiments, the processor 242 may process all item data that is received or stored in the distribution network 10. In other embodiments, the processor 242 may process selected ones of the item data. For example, the processor 242 may select items having higher service class (e.g., first class), having higher financial value, or having higher insurance amounts. As another example, the processor 242 may randomly select items and process the randomly selected item data.

In some embodiments, the process 300 and other processes described herein can be performed automatically at certain intervals. In some embodiments, a particular shipper or sender can request one-time or reoccurring performance of process 300 and/or other processes described herein to identify and correct delivery issues. For example, a shipper may have an account with the distribution system and may ship a large volume of items. The shipper may have as part of the account, a plan or may pay an added fee for routine identification of delivery issues of the shipper's items via process 300 and other processes described herein. In some embodiments, the process 300 and other processes described herein is performed on all items processed on a specific piece of equipment. In some embodiments, the item data used can relate to a geographical area, to items sent by a common shipper, items processed in a particular location or by a particular delivery resource, or can occur on an ad hoc basis as requested by an operator or supervisor.

In state 330, the processor 242 may determine whether one or more delivery issues of an item are detected or found. The delivery issues may include, but are not limited to: missing arrival scan, missing “out for delivery” scan, delivery scan made in a location that is over x distance away from actual destination coordinates, a scan made in a location that is not consistent with the delivery plan, a discrepancy between an electronic record of an item and scanned data of an actually received item, pre-shipment information sent to the distribution network 10 but no acceptance scan made within a predetermined of time, network predicted delivery date earlier than the service performance date, an item received by the distribution network 10 but not delivered after x days, out for delivery scan made but no delivery scan made by x local time, or an item undeliverable as addressed (UAA). In some embodiments, the processor 242 may determine that there are delivery issues when one of the above issues is detected or found. In other embodiments, the processor 242 may determine that there are delivery issues when two or more of the above issues are detected or found. In some embodiments, when one or more delivery issues are detected, the processor 242 may add one or more additional conditions to confirm that there is a delivery issue depending on whether the additional conditions are met. These are merely examples, and there may be other examples that may be detected or determined as delivery issues.

When it is determined in state 330 that no delivery issues are detected or found, the process flow diagram 300 may end. This may mean that the item at issue has been or will be delivered or processed on time or within managed expectations.

When it is determined in state 330 that delivery issues are detected or found, the processor 242 may automatically generate an internal case file (state 340). The processor 242 may store the generated internal case file in one or more of the DBs or memories described above so that the internal case file can be accessed by one of the facilities 104a-108b. In some embodiments, one or more of the carrier, the operator, the clerk, a sender, or a recipient may also access the internal case file and the status thereof.

The internal case file may, for the missing, misrouted, delayed, etc. item, include, but is not limited to, one or more of an image of an item (if available), a last known or scanned location of the item based on last scan data, a theoretical or expected next location of the item, contact information of an item coordinator in the last known or expected next location of the item, a drop shipper's contact information in the event that the item was not scanned as received at a facility but could have actually been received in the distribution network 10, a discrepancy between a facility where the items was scanned and an expected facility according to a delivery plan, a distance between delivered scan coordinates (where the scan was made) and actual destination (including map/directions information) (if applicable), or an explanation provided if UAA. In some embodiments, an item containing, e.g., valuable objects or human remains, may include a tracking device such as a beacon, an RFID tag or GPS, etc., disposed on, embedded into or attached to the item. In these embodiments, the internal case file may include a last known reported indoor location and facility name. The above are merely examples of information that can be included in the internal case file, but other information that may help locate, identify, reroute, expedite, change service class, or take other action for the item can also be included.

In state 350, the processor 242 may determine whether a solution for an item having a delivery issue has been found. For example, the processor 242 may locate, reroute, expedite, etc., the item and/or take steps to address or resolve the delivery issues. In some embodiments, the processor 242 may expedite the delivery process for the located item. For example, when the original shipping method of the item was lower priority/regular shipping (or less expensive shipping), the processor 242 may upgrade or escalate the shipping method of the located item to intermediate level priority/intermediate level shipping (intermediate shipping cost) or higher priority/expedited shipping (or more expensive shipping). The processor 242 may determine the upgraded level based on one or more of latency (i.e., how long the delay was), the original shipping cost, the value of the item, or insured amount of the item, etc. When the located item is found as UAA, the processor 242 may not escalate the processing but generate an explanation that the item was returned as being UAA. In some embodiments, the processor 242 may assign the internal case file generated in state 340 to a facility that made the last scan or should have made an acceptance scan of the missing item so that the facility can process the internal case file. The above are merely examples, and other solutions may also be possible.

If it is determined in state 350 that no solution is found, the processor 242 may repeat the state 350 until a solution for the item having a delivery issue is found. If it is determined in state 350 that a solution is found, the processor 242 may send notification with the solution (state 360). For example, the processor 242 may notify a destination site regarding the delivery issue, the solution found, and/or explanation about the delay in delivery. As another example, the processor 242 may generate and send a notification to a customer of a delayed item with updated expected delivery time and other useful or necessary information about the item. In some embodiments, the processor 242 may expedite the notification process depending on how the delivery issue occurred. For example, when an “out for delivery scan” was made but no delivery scan was made by x local time on that day, the processor 242 may send a notification or alert to the relevant delivery unit more quickly (e.g., the next day) to confirm the delivery status. As another example, when a customer called a delivery unit or facility in the distribution network 10 before he/she is notified, the processor 242 may pull up the generated internal case file and notify the relevant unit facility to expedite the notification process. In some embodiments, the processor 242 may communicate with a customer service phone and retrieve relevant information based on a customer's phone number or using a caller ID and control the customer service phone to provide the status of the customer's item.

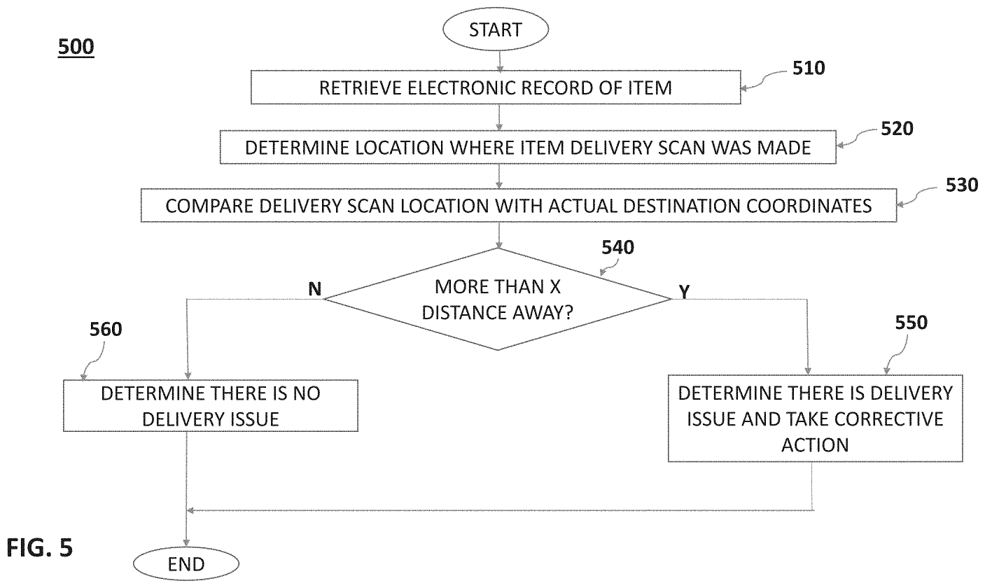

FIG. 4 is an exemplary process flow diagram 400 of a method for automatically detecting item delivery issues in the distribution network 10 according to some embodiments. For the purpose of convenience, the description will be provided based on the processor 242 performing the flow diagram 400. FIG. 4 shows an example process for detecting item delivery issues and the processor 242 may detect delivery issues based on other events and/or scenarios including (but not limited to) those shown in FIGS. 5-8.

In state 410, the processor 242 may retrieve an electronic record of an item stored in the distribution network 10. The retrieved electronic item record can be selected randomly, can be specifically requested for a specific item, can be a plurality of items associated with a particular shipper, etc. The process 400 may use item records described with regard to FIG. 3. For example, the electronic record of the item may be stored in one or more of the processor 242, the memory 244, the item information DB 230 or the carrier terminal DB 220 shown in FIG. 2 or a network memory such as a cloud (not shown).

In state 420, the processor 242 may determine whether an item arrival scan is missing. In some embodiments, the processor 242 may determine whether an arrival scan is received for an item that is not intended to be at the facility conducting the arrival scan. When an item arrives at a unit facility, the item may be scanned and the scanned data may be stored in one or more of the processor 242, the memory 244, the item information DB 230, the carrier terminal DB 220 or a network memory such as a cloud. The processor 242 may determine based on the electronic record of the item whether the arrival scan data for the item exists in the distribution network 10. When the arrival scan data for an item does not exist, the processor 242 may determine in state 420 that the item arrival scan is missing.

When it is determined in state 420 that the item arrival scan is not missing (i.e., exists in the distribution network 10), the processor 242 may determine whether an “out for delivery” scan is missing (state 430). Once arrival scans are made on items, the items may be scanned again before a carrier goes out for delivery of the items. The “out for delivery” scan data may also be stored in the distribution network 10, e.g., in one or more of the processor 242, the memory 244, the item information DB 230, the carrier terminal DB 220 or a network memory such as a cloud. The processor 242 may determine based on the electronic record of the item whether the “out for delivery” scan data exists in the distribution network 10. When the “out for delivery” scan data for an item does not exist, the processor 242 may determine in state 430 that the “out for delivery” scan is missing.

When it is determined in state 430 that the “out for delivery” scan is not missing (i.e., exists in the distribution network 10), the processor 242 may determine that there is no delivery issue for the item (state 450) and the procedure 400 may end. When it is determined in state 420 that the item arrival scan is missing or when it is determined in state 430 that the “out for delivery” scan is missing, the processor 242 may determine that there is a delivery issue for the item and take corrective action in state 440.

When an arrival scan, such as an arrival at unit scan is missing for an item, the server 240 may access the item information DB 230 to determine if the item missing the arrival scan has been scanned at a different location. If the item has been received and scanned at an incorrect location or facility, based on the delivery plan determined at induction of the item, the server 240 changes the delivery plan for the item in order to move the item toward the correct distribution facility, and instructs the item processing equipment to reroute the item toward the correct destination. In some embodiments, where there is a service class issue, the server 240 may upgrade the service class of the item in order to expedite movement of the item to the correct distribution network facility. For example, an item under a standard shipping service class may be upgraded to a priority mail class, first class, or another class, in order to expedite the item delivery.

If the item cannot be located at a different facility, the server 240 can alert the facility at the last known location to perform a search for the item. In some embodiments, the server 240 can identify, for the last known scan location, the item which was scanned immediately previous to the item with the issue and the item scanned subsequent to the scan of the missing item. The server 240 can then alert the facilities or locations to which the preceding and subsequent items have been moved to, or the containers in which those items are located, in order to find the item with the delivery issue.

In some embodiments, the server 240 can flag the item record for the item with the issue and await a subsequent scan of the item. In some embodiments, the server 240 can generate and send a notification to the intended recipient regarding the delivery issue, and including any corrective action or updated delivery estimates, as appropriate.

If the item is missing an out for delivery scan in decision state 430, the server 240 may access the item information DB 230 to determine if the item is at the correct unit delivery facility for delivery. The server 240 may send an alert to the carrier terminal 210 of the delivery resource who is intended to deliver the item to the intended delivery point, such as the carrier who should be delivering the item. The server 240 can request that the carrier search through the items to be delivered along the carrier's route to find the item. If the carrier finds the item, the carrier can scan the item for the out for delivery scan, or the carrier can acknowledge, via the carrier terminal 210, that the item is located. This can be recorded by the server 240 as a vicarious or implied out for delivery scan. If the item is not located with the carrier, the server 240 can alert the previous facility to search for the item.

FIG. 5 is another exemplary process flow diagram 500 of a method for automatically detecting item delivery issues in the distribution network 10 according to some embodiments. For the purpose of convenience, the description will be provided based on the processor 242 performing the flow diagram 500.

In state 510, the processor 242 may retrieve an electronic record of an item from one of the DBs or memories in the distribution network 10, as described above. In state 520, the processor 242 may determine the location where an item delivery scan was made. When a carrier delivers an item, the carrier may perform an item delivery scan via the carrier terminal 210 shown in FIG. 2. The item delivery scan data may include information regarding the recipient, delivery time and/or delivery location (e.g., address), etc. The item delivery scan data may be stored in the distribution network 10, e.g., in one or more of the processor 242, the memory 244, the item information DB 230, the carrier terminal DB 220 or a network memory such as a cloud.

In state 530, the processor 242 may compare the delivery scan location (determined in state 520) with actual destination coordinates of the item. The processor 242 may determine the actual destination coordinates of the item based on the electronic record retrieved in state 510. When the delivery scan location and the actual destination coordinates match, this means that the item has been properly delivered to an intended recipient. When there is a discrepancy between the two, this means that the item may not have been properly delivered to an intended recipient.

In state 540, the processor 242 may determine whether the delivery scan location is over a predetermined distance away from the actual destination coordinates of the item. In some embodiments, the predetermined distance can be in the range of several meters to several miles. In some embodiments, the processor 242 may determine that the delivery scan location is over a predetermined distance away, when the two locations are several blocks away or in different Zip code areas. In other embodiments, the processor 242 may determine that the delivery scan location is over a predetermined distance away, when, for example, the expected travel time between the intended location and the scan location is more than a predetermined distance or amount of time (e.g., in the range of several minutes to several hours). In some embodiments, even if the delivery scan location is not over a predetermined distance away, if the travel time is over a predetermined of time (e.g., due to traffic), the processor 242 may determine that the delivery scan location is over a predetermined distance away and move to state 550.

When it is determined in state 540 that the delivery scan location is not over a predetermined distance away from the actual destination coordinates of the item, the processor 242 may determine that there is no delivery issue for the item (state 560) and the procedure 500 may end. When it is determined in state 540 that the delivery scan location is over a predetermined distance away from the actual destination coordinates of the item, the processor 242 may determine that there is a delivery issue for the item in state 550 and the processor 242 may initiate and take corrective action. In other embodiments, the processor 242 may determine that there is a delivery issue, when the delivery scan location and the actual destination coordinates do not exactly match, even though the delivery scan location is within a predetermined distance from the actual destination coordinates of the item.

In state 550, the processor 242 may send a notification to the carrier terminal 210 of the carrier who was intended to deliver the item. This communication may be sent immediately upon receipt of the incorrect scan, in order to allow the carrier to correct the issue as soon as possible. In some embodiments, the carrier can input via the carrier terminal 210 an acknowledgement and a correction of the action. In some embodiments, the carrier may indicate that the item was correctly delivered and that the location coordinate of the delivery was incorrect.

In some embodiments, the processor 242 may identify the delivery point associated with the delivery scan location, and can send a notification to that intended recipient according to contact information stored with the distribution network 10. In some embodiments, the processor 242 can send a notification to the intended recipient that the item was delivered to an incorrect delivery point, and an estimate when the item will be picked up from the incorrect point and be delivered to the correct delivery point. In some embodiments, where the incorrect delivery point is near the correct delivery point, such as on the same street, in the same neighborhood, in the same building, etc., the processor 242 can alert the intended recipient of the location of the incorrect delivery.

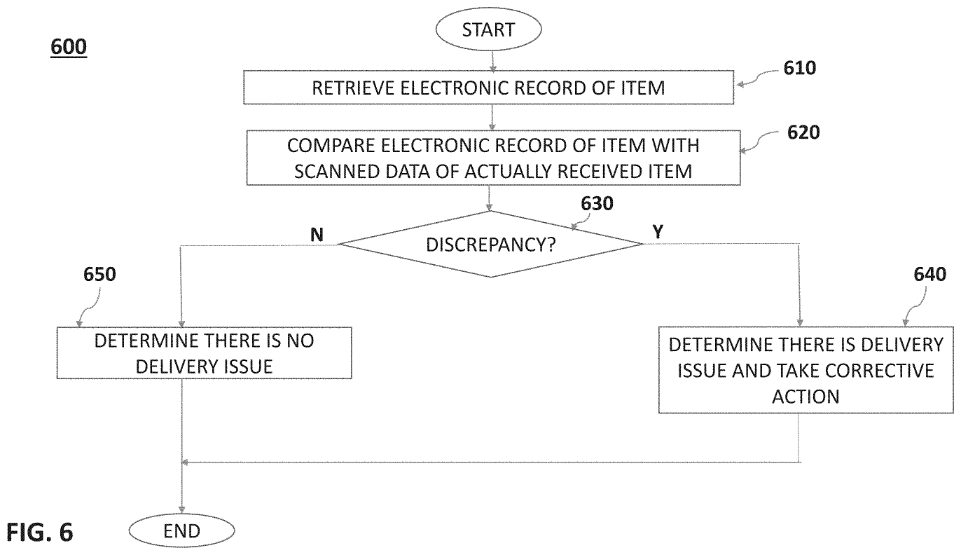

FIG. 6 is another exemplary process flow diagram 600 of a method for automatically detecting item delivery issues in the distribution network 10 according to some embodiments. For the purpose of convenience, the description will be provided based on the processor 242 performing the flow diagram 600.

In state 610, the processor 242 may retrieve an electronic record of an item from one of the DBs or memories in the distribution network 10 described above. In state 620, the processor 242 may compare the electronic record of the item with the arrival scan data made at a unit facility. The arrival scan data may include data indicating that the item has been actually received by the unit facility. The arrival scan data may include information about the relevant item, and delivery information such as a recipient name, address, expected delivery date, etc. For example, a shipper may send an electronic record for a plurality of items being delivered or dropped at a distribution network facility. The induction, arrival, or ingest scans of those items can be compared to the electronic records.

In state 630, the processor 242 may determine whether there is a discrepancy between the electronic record of the item and the arrival scan data. For example, when the electronic record does not match the item information contained in the arrival scan data, the processor 242 may determine that there is a discrepancy between the electronic record of the item and the arrival scan data. Or, a discrepancy can be identified if the electronic record of the plurality of items indicates that there were more items on the electronic records than items that were scanned. In some embodiments, a discrepancy can be identified if an item scanned at the facility may not be on the electronic record, but may have a code thereon indicating it is from the same shipper. The processor 242 may determine that the electronic record and the arrival scan data do not match, when at least some of delivery information does not match in the two pieces of data.

When it is determined in state 630 that there is no discrepancy between the electronic record of the item and the arrival scan data or the two data are consistent with each other, the processor 242 may determine that there is no delivery issue for the item (state 650) and the procedure 600 may end. When it is determined in state 630 that there is a discrepancy between the electronic record of the item and the arrival scan data, the processor 242 may determine that there is a delivery issue for the item in state 640, and corrective action can be taken.

When there is a discrepancy, the processor 242 can communicate with the systems of a shipper to indicate that an item having an electronic record was not physically received and/or scanned. The processor 242 can communicate that an incorrect item, or an item not having an electronic record was physically received and scanned. In some embodiments, where the particulars of item information are incorrect, the processor 242 can request additional payment for shipping, such as when the dimensions or weights are different than those in the electronic record, or where the item destinations on the items are different than those in the electronic record. The processor 242 can update the delivery plan for items that have different intended destinations on the physical items than those in the electronic records. In these cases, the processor 242 can determine an estimated delivery time based on the correct delivery point information, and can communicate that to the intended recipient. In some embodiments, the processor 242 can communicate the information to the shipper, and the shipper can communicate with the intended recipients of the items.

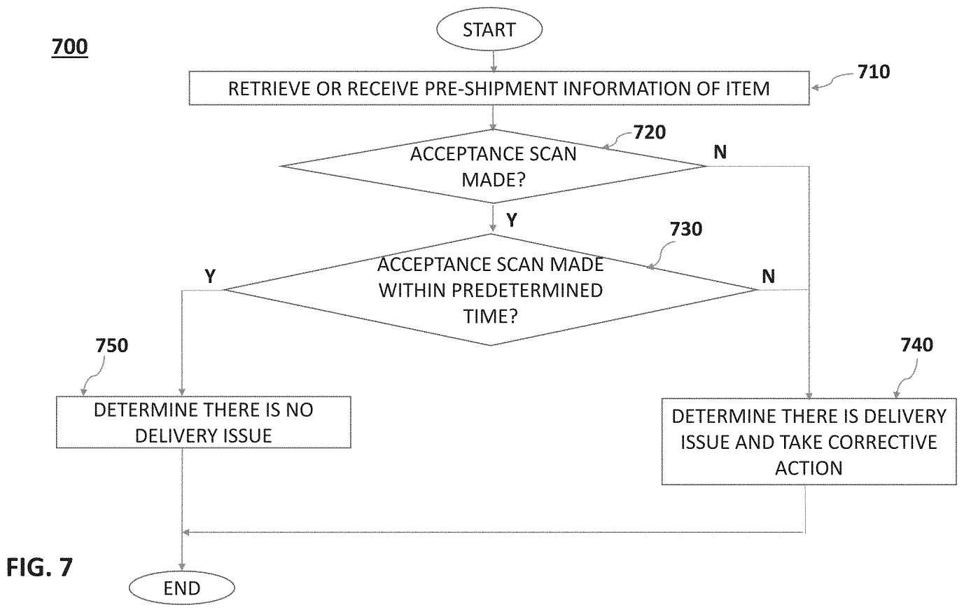

FIG. 7 is another exemplary process flow diagram 700 of a method for automatically detecting item delivery issues in the distribution network 10 according to some embodiments. For the purpose of convenience, the description will be provided based on the processor 242 performing the flow diagram 700.

In state 710, the processor 242 may retrieve or receive pre-shipment information of an item. In some embodiments, when a customer ships an item, pre-shipment information of the item can be stored in the distribution network 10 such as in the memory 244, the item information DB 230, the carrier terminal DB 220 or a network memory such as a cloud. In these embodiments, the processor 242 may retrieve the pre-shipment information of the item from one or more of the memory 244, the item information DB 230, the carrier terminal DB 220 or a network memory such as a cloud.

In some embodiments, when a customer ships an item, the processor 242 may directly or indirectly receive the pre-shipment information of the item, for example, from a customer's terminal. In these embodiments, the pre-shipment information of the item may not necessarily be stored in the distribution network 10.

In state 720, the processor 242 may determine whether an acceptance scan has occurred for the item. For example, the acceptance scan may be made at a unit facility such as 104a or 104b shown in FIG. 1. However, when the item is received by any one of the facilities 106a-108b in the distribution network 10, the acceptance scan may also be made in those larger facilities.

When it is determined in state 720 that the acceptance scan has been made, the processor 242 may determine whether the acceptance scan has occurred within a predetermined time from the time when the pre-shipment information of the item was received (state 730). The predetermined time may be, for example, in the range of 6 hours to 48 hours, for example 24 hours. In some embodiments, the predetermined time can be based on the service class for the items, or delivery guarantees made by the shipper and/or the distribution network 10.

When it is determined in state 730 that the acceptance scan has occurred within the predetermined time, the processor 242 may determine that there is no delivery issue for the item (state 750) and the procedure 700 may end. When it is determined in state 720 that the acceptance scan has not been made or when it is determined in state 730 that the acceptance scan has not been made within a predetermined time, the processor 242 may determine that there is a delivery issue for the item in state 740 and the processor 242 may initiate or take corrective action.

When the arrival or acceptance scans have not been performed within the predetermined time period, the processor 242 can generate and send a notification to the shipper or the entity who provided the pre-shipment information regarding the elapsed predetermined time. The processor 242 can also generate and send information to the intended recipient regarding the delay.

In some embodiments, the processor 242 can access the item information DB 230 to identify whether the items have been received at a location other than the intended location. For example, a shipper may drop the items at a facility other than at the expected facility. In this case the processor 242 can inform the shipper of the discrepancy, can update payment requirements, and can automatically adjust the delivery plans for the items to reroute the items as required to deliver the items to the intended delivery points.

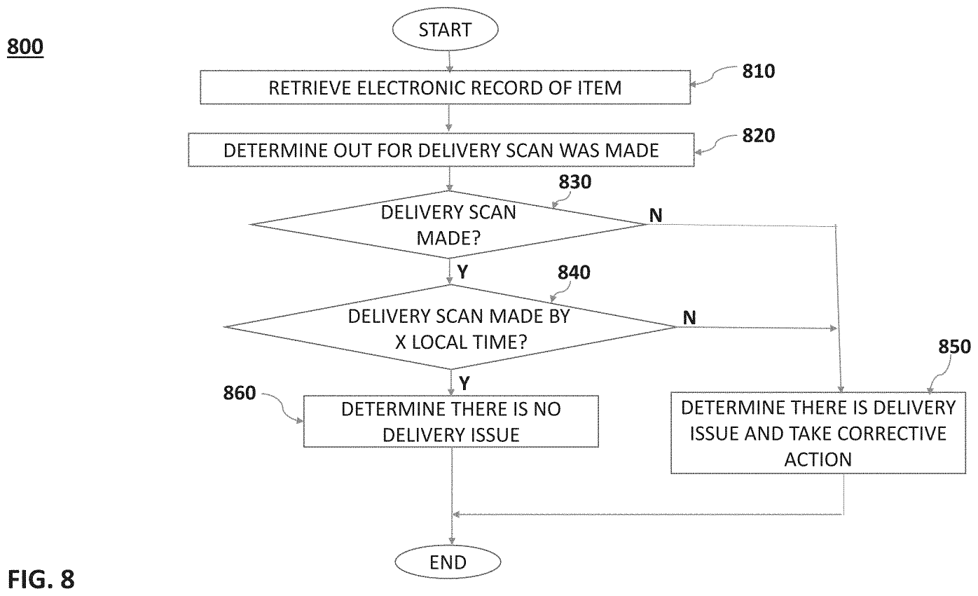

FIG. 8 is another exemplary process flow diagram 800 of a method for automatically detecting item delivery issues in the distribution network 10 according to some embodiments. For the purpose of convenience, the description will be provided based on the processor 242 performing the flow diagram 800.

In state 810, the processor 242 may retrieve an electronic record of an item from one of the DBs or memories in the distribution network 10 described above. In state 820, the processor 242 may determine whether an “out for delivery” scan has occurred. For example, the processor 242 may determine that the “out for delivery” scan has occurred based on scan data stored in one or more of the DBs or memories in the distribution network 10 described above.

In state 830, the processor 242 may determine whether a delivery scan has occurred for the item. As described above, when an item is delivered to a recipient, a carrier may perform a delivery scan via the carrier terminal 210 confirming that the item has been delivered.

When it is determined in state 830 that the delivery scan has occurred, the processor 242 may determine whether the delivery scan has been made by a predetermined local time in the area the recipient resides (state 840). The predetermined local time may be, for example, in the range of 9 AM to 9 PM, for example, 6 PM, local time.

The process 800, and other processes described herein, can be commenced at a given time in a day for each item or electronic item record. The time to commence the process can be a set time after an out for delivery scan or other scan or handling event. For example, the processor 242 may initiate process 800 for items when a predetermined number of hours or minutes has elapsed since the out for delivery scan occurred, or when the carrier with the item left the facility. In this way, the system can proactively identify potential problems.

When it is determined in state 840 that the delivery scan has occurred by a predetermined local time, the processor 242 may determine that there is no delivery issue for the item (state 860) and the procedure 800 may end. When it is determined in state 830 that the delivery scan has not been made or when it is determined in state 840 that the delivery scan has not been made by a predetermined local time, the processor 242 may determine that there is a delivery issue for the item in state 850 and the processor 242 may take corrective action.

The processor 242 can generate a notification to the carrier with the item that has not been delivered yet, or which was delivered without a required scan. In some embodiments, the processor 242 can send a notification to the intended recipient to confirm delivery of the item, or can send notification of delay or an updated delivery time. In some embodiments, the processor 242 can provide refund of payment or other incentives to compensate for the delay or missing delivery service. This can be applicable to any of the scenarios described herein.

In some embodiments, when the processor 242 determines that there is a delivery issue under the processes of FIGS. 3-8, or any other scenario, an item record can be updated to reflect the issue, or an issue record can be created and stored in the item information DB 230. When a customer identifies a delivery issue, or requests status about an item, such as, via a web application, a mobile application, a call center, etc., the processor 242 can automatically provide the information from the item record or the issue record, and can provide information about scans, actions being taken, updated information, and the like.

In some embodiments, a non-transitory computer readable medium having stored thereon instructions which when executed by at least one computing device performs all or a portion of the methods described. Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. An image processing system can be or include a microprocessor, but in the alternative, the image processing system can be or include a controller, microcontroller, or state machine, combinations of the same, or the like configured to generate and analyze indicator feedback. An image processing system can include electrical circuitry configured to process computer-executable instructions. Although described herein primarily with respect to digital technology, an image processing system may also include primarily analog components. For example, some or all of the image file analysis and rotation notation features described herein may be implemented in analog circuitry or mixed analog and digital circuitry. A computing environment can include a specialized computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in specifically tailored hardware, in a specialized software module executed by an image processing system, or in a combination of the two. A software module can reside in random access memory (RAM) memory, flash memory, read only memory (ROM), erasable programmable read-only memory (EPROM), electrically erasable programmable read-only memory (EEPROM), registers, hard disk, a removable disk, a compact disc read-only memory (CD-ROM), or other form of a non-transitory computer-readable storage medium. An exemplary storage medium can be coupled to the image processing system such that the image processing system can read information from, and write information to, the storage medium. In the alternative, the storage medium can be integral to the image processing system. The image processing system and the storage medium can reside in an application specific integrated circuit (ASIC). The ASIC can reside in an access device or other monitoring device. In the alternative, the image processing system and the storage medium can reside as discrete components in an access device or other item processing device. In some embodiments, the method may be a computer-implemented method performed under the control of a computing device, such as an access device or other item processing device, executing specific computer-executable instructions.

Conditional language used herein, such as, among others, “can,” “could,” “might,” “may,” “e.g.,” and the like, unless specifically stated otherwise, or otherwise understood within the context as used, is generally intended to convey that some embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some embodiments, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML, document, fixed field message, comma separated message, or the like. A message may, in some embodiments, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A system for automatically detecting and resolving item delivery issues in a distribution network, comprising:
a memory configured to store electronic records of a plurality of items received by the distribution network; and
a processor in data communication with the memory and configured to:
process the electronic records of the plurality of items;
determine whether there is a delivery issue on at least one of the plurality of items based on the electronic records;
automatically initiate a corrective action in response to determining that there is a delivery issue on the at least one item; and
send notification to a computing device of an intended recipient of the at least one item having the delivery issue.

2. The system of claim 1, wherein the notification comprises one or more of an updated delivery date, an upgraded service class or an explanation of the delivery issue for the at least one item having the delivery issue.

3. The system of claim 1, wherein the processor is further configured to:
receive item processing information from at least one of a carrier terminal or an operator terminal in data communication with the distribution network, the item processing information comprising one or more of arrival scan data, out for delivery scan data, delivery scan data or acceptance scan data associated with the plurality of items.

4. The system of claim 3, wherein the processor is further configured to:
determine whether an arrival scan for the at least one item is missing;
determine whether an out for delivery scan for the at least one item is missing; and
determine that there is a delivery issue on the at least one item in response to determining that at least one of the arrival scan or the out for delivery scan is missing.

5. The system of claim 3, wherein the processor is further configured to:
determine a delivery scan location of the at least one item in which a delivery scan on the at least one item occurred;
compare the delivery scan location with an actual destination coordinate of the at least one item; and
determine that there is a delivery issue on the at least one item when the delivery scan location is over a predetermined distance away from the actual destination coordinate.

6. The system of claim 3, wherein the processor is further configured to:
retrieve an electronic record of the at least one item from the memory;
retrieve arrival scan data or acceptance scan data for the at least one item;
compare the electronic record of the at least one item with item information contained in the arrival scan data or the acceptance scan data; and
determine that there is a delivery issue for the at least one item when there is a discrepancy between the electronic record of the at least one item and the item information contained in the arrival scan data or the acceptance scan data.

7. The system of claim 3, wherein the processor is further configured to:
receive pre-shipment information of the at least one item;
determine whether an item acceptance scan for the at least one item has occurred;
determine whether the item acceptance scan for the at least one item occurred within a predetermined time from a time when the pre-shipment information of the at least one item was received; and
determine that there is a delivery issue for the at least one item in response to determining that the item acceptance scan has not occurred or that the item acceptance scan has not occurred within the predetermined time.

8. The system of claim 3, wherein the processor is further configured to:
retrieve an electronic record of the at least one item;
determine that an out for delivery scan for the at least one item has occurred;
determine whether an item delivery scan for the at least one item has occurred;
determine whether the item delivery scan has occurred by a predetermined local time in an area where an intended recipient resides; and
determine that there is a delivery issue on the at least one item in response to determining that the item delivery scan has not been made or that the item delivery scan has not been made by the predetermined local time.

9. The system of claim 1, wherein the at least one item having the delivery issue comprises a tracking device disposed on, embedded into or attached thereto, and wherein the processor is configured to track a location of the at least one item based on the tracking device in response to determining that there is a delivery issue on the at least one item.

10. A method of automatically detecting and resolving item delivery issues in a distribution network, comprising:
storing, at a memory, electronic records of a plurality of items received by the distribution network;
processing, at a processor, the electronic records of the plurality of items;
determining, at the processor, whether there is a delivery issue on at least one of the plurality of items based on the electronic records;
automatically generating, at the processor, an internal case file in response to determining that there is a delivery issue on the at least one item; and
sending, at the processor, notification to a computing device of an intended recipient of the at least one item having the delivery issue.

11. The method of claim 10, wherein the notification comprises one or more of an updated delivery date, an upgraded service class or an explanation of the delivery issue for the at least one item.

12. The method of claim 11, wherein the storing comprises storing, at the memory, item processing information comprising one or more of item arrival scan data, out for delivery scan data, item delivery scan data or item acceptance scan data associated with the plurality of items.

13. The method of claim 12, wherein the determining comprises:
determining, at the processor, whether an arrival scan on an item is missing;
determining, at the processor, whether an out for delivery scan for the at least one item is missing on the at least one item;
determining, at the processor, that there is a delivery issue on the at least one item in response to determining that at least one of the arrival scan or the out for delivery scan is missing; and
determining, at the processor, that there is no delivery issue on the at least one item in response to determining that neither of the arrival scan and the out for delivery scan is missing.

14. The method of claim 11, wherein the determining comprises:
determining, at the processor, a delivery scan location of an item where a delivery scan for the at least one item has occurred;
comparing, at the processor, the delivery scan location with an actual destination coordinate of the at least one item; and
determining, at the processor, that there is a delivery issue on the at least one item when the delivery scan location is over a predetermined distance away from the actual destination coordinate.

15. The method of claim 11, wherein the determining comprises:
retrieving, at the processor, an electronic record of an item from the memory;
retrieving, at the processor, arrival scan data or acceptance scan data on the at least one item;
comparing, at the processor, the electronic record of the at least one item with item information contained in the arrival scan data or the acceptance scan data; and
determining, at the processor, that there is a delivery issue on the at least one item when there is a discrepancy between the electronic record of the at least one item and the item information contained in the arrival scan data or the acceptance scan data.

16. The method of claim 11, wherein the determining comprises:
retrieving, at the processor, pre-shipment information of an item;
determining, at the processor, whether an item acceptance scan for the at least one item has occurred;
determining, at the processor, whether the item acceptance scan for the at least one item has occurred within a predetermined time from a time when the pre-shipment information of the item was received; and
determining, at the processor, that there is a delivery issue on the at least one item in response to determining that the item acceptance scan has not been made or that the item acceptance scan has not been made within the predetermined time.

17. The method of claim 11, wherein the determining comprises:
retrieving, at the processor, an electronic record of an item from the memory;
determining, at the processor, that an out for delivery scan for the at least one item has occurred;
determining, at the processor, whether an item delivery scan for the at least one item has occurred;
determining whether the item delivery scan has occurred by a predetermined time; and
determining, at the processor, that there is a delivery issue for the at least one item in response to determining that the item delivery scan has not been made or that the item delivery scan has not been made by the predetermined local time.

18. A system for automatically detecting and resolving item delivery issues in a distribution network, comprising:
means for storing electronic records of a plurality of items received by the distribution network, the storing means comprising a memory; and
means for processing the electronic records of the plurality of items;
means for determining whether there is a delivery issue on at least one of the plurality of items based on the electronic records;
means for automatically generating an internal case file in response to determining that there is a delivery issue on the at least one item; and
means for sending notification to a computing device of an intended recipient of the at least one item having the delivery issue,
at least one of the processing means, the determining means, the automatically generating means or the sending means comprising a processor.

19. The system of claim 18, wherein the notification comprises one or more of an updated delivery date, an upgraded service class or an explanation of the delivery issue for the at least one item.

20. The system of claim 18, further comprising:
means for receive item processing information from at least one of a carrier terminal or an operator terminal in data communication with the distribution network, the item processing information comprising one or more of arrival scan data, out for delivery scan data, delivery scan data or acceptance scan data associated with the plurality of items.
